(19) United States
(12) Patent Application Publication
(10) Pub. No.: US 2011/0214355 A1
(43) Pub. Date: Sep. 8, 2011

(54) DOOR GAP PROTECTOR

(76) Inventor: James S. Kim, Carrollton, TX (US)

(21) Appl. No.: 12/913,269

(22) Filed: Oct. 27, 2010

(30) Foreign Application Priority Data
Mar. 5, 2010 (KR) 10-20100019823

(51) Int. Cl. E05D 11/00

(52) U.S. Cl. 49/383; 16/223

(57) ABSTRACT

A protective device which closes and seals the gap which forms between a pivotally mounted door and its jamb. The protective device generally spans the door and jamb, and occupies and generally does not extend outside the gap. The protective device may include an elastic or resilient or expansive material or member, and a fastener securing the protective device in place relative to the door and the jamb.

### REFERENCE TO RELATED APPLICATION

This application claims priority to U.S. Non-Provisional patent application Ser. No. 12/122,022, filed May 16, 2008 and KOREA Patent Application Serial No. 10-20100019823, filed Mar. 5, 2010.

### FIELD OF THE INVENTION

The present invention relates to doors and closures, and more particularly, for an accessory to prevent people from inserting their fingers and other objects into the gap which exists between a door and its jamb when the door is opened.

### BACKGROUND OF THE INVENTION

Most doors are pivotally mounted to building to swing about a vertical axis. Doors are conventionally arranged to fit flushly to their associated door jambs. A gap is exposed when the door is swung open. Adults have little trouble with this gap, but children are apt to get fingers caught in the gap.

Devices for sealing the gap exposed by a door have been proposed. Most of these are external to the gap and therefore project from the door and jamb to a degree that is unsightly or otherwise objectionable.

### SUMMARY OF THE INVENTION

The present invention sets forth a gap protector for a door and jamb which avoids objectionable intrusion into the field of sight of an observer. The gap protector occupies the gap itself and expands so as to present a barrier covering the gap between the door and its jamb despite progressive increase in magnitude of the gap.

The gap protector comprises a variable width expansible member disposed within the gap. According to one aspect of the invention, the expansible member may comprise a plurality of separate members which are urged apart, so that one member contacts the jamb and the other the door. Both members are pivotally connected to present a continuous barrier covering the gap. According to another aspect of the invention, the expansible member may be resilient. According to a further aspect of the invention, the expansible member may be elastic.

Regardless of the nature of the expansible member, it is substantially limited to the void space existing between the door and its jamb, regardless of variations of this void space as the door swings open and shut, and does not unduly extend outside this void space.

The gap protector includes a fastener for securing the gap protector to its mounting relative to the door and jamb.

It is an object of the invention to provide a covering for a gap which develops between a door and an associated jamb to which the door is pivotally connected, as the door is opened and closed.

It is another object of the invention to limit the covering so that it occupies and generally does not extend outside the void space of the gap.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an environmental perspective view of one aspect of the invention, shown partly broken away.

FIG. 2 is a front perspective view of another aspect of the invention.

FIG. 3 is a side perspective view of a third aspect of the invention, shown partly broken away.

FIG. 4 is a perspective detail view of a spring seen at the center left of FIG. 3.

FIG. 5 is a perspective view of a fourth aspect of the invention, shown partly broken away.

FIG. 6 is a perspective partial view of a fifth aspect of the invention.

FIG. 7 is a perspective partial view of a sixth aspect of the invention.

FIG. 8 is a top plan view of a conventional hinge mounted door.

FIG. 9 is an environmental top plan view of a door and jamb, showing a sixth aspect of the invention, with the door in a partially open position.

FIG. 10 is an environmental top plan view of FIG. 11, showing the door in a closed position.

FIG. 11 is a top plan detail view of a component seen at the top of FIG. 9.

FIG. 12 is a top plan detail view of a component similar to that of FIG. 9, but according to another aspect of the invention.

FIG. 13 is a perspective view of a gap protecting arrangement according to a further aspect of the invention.

FIG. 14 is an exploded perspective view of the components of FIG. 13, also showing additional components omitted from FIG. 13.

FIG. 15 is a top plan view of a gap protecting arrangement according to still another aspect of the invention.

FIG. 16 is similar to FIG. 15, but shows a positional adjustment of components of the assembly of FIG. 15.

FIG. 17 is an exploded top plan view of a gap protecting arrangement according to yet another aspect of the invention.

FIG. 18 is an environmental top plan view of a gap protecting arrangement according to another aspect of the invention.

### DETAILED DESCRIPTION OF THE PREFERRED EMBODIMENTS

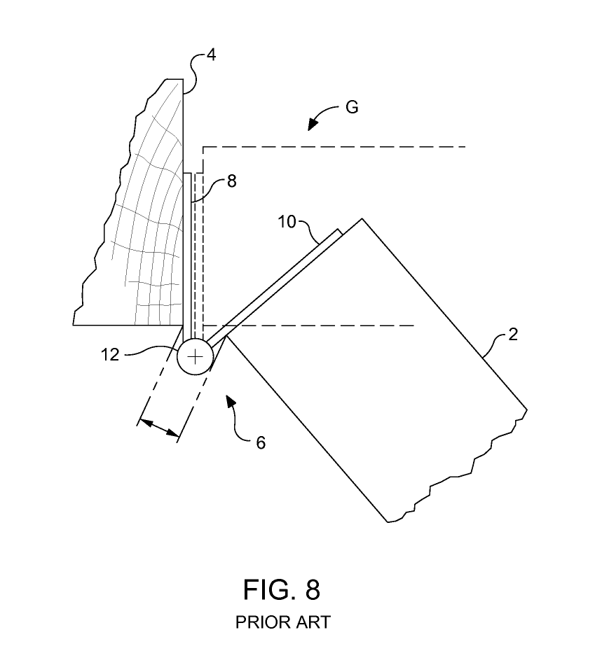

FIG. 8 illustrates the problem which is solved by the present invention. A door 2 is pivotally connected to an associated jamb 4 by a hinge 6 having a first hinge plate 8 and a pivotally connected second hinge plate 10. The hinge 6 has a hinge pin 12 about which other hinge elements pivot, to enable the door 2 to assume any of a plurality of door angles, within a limited range. The hinge pin 12 conventionally may include an enlarged head to prevent the shaft of the hinge pin 12 (the shaft is not visible in the top plan view of FIG. 8).

The door 2 is shown in its closed position in broken lines. In the closed position, no gap which could entrap and injure a person's finger or fingers normally exists. However, as the door 2 is opened, an exemplary open angular position shown in solid lines in FIG. 8, a gap G is seen to develop. It is important to note that the gap G is accessible not only from the large opening shown at the upper portion of FIG. 8, but also from the side bearing the hinge 12. In many cases, it is the latter approach that proves most dangerous to small children who have not yet developed awareness that the gap G exists and may injure them should a finger or fingers be inserted into the gap G and the door 2 closed.

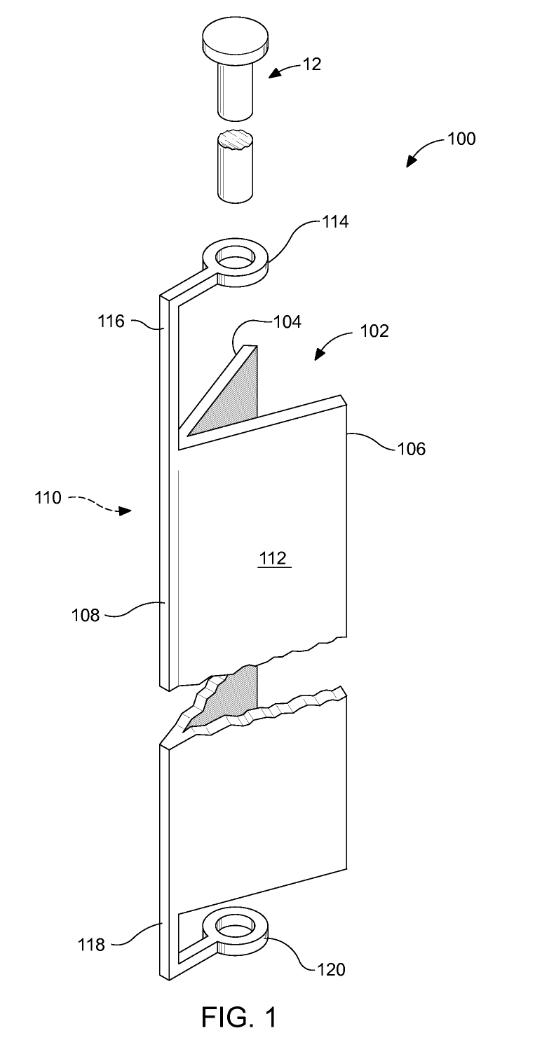

FIG. 1 shows a gap protecting arrangement 10 according to one aspect of the invention, for obstructing insertion of small objects (not shown) into the gap G which has been explained with reference to FIG. 8. The gap protecting arrangement 100 may include a generally Vee-shaped member 102 having a panel 104 and a second panel 106. The panels 104 and 106 are joined at a joint 108 which may extend the full height of the panels 104 and 106, as depicted. The first panel has a first contact surface 110 which may face a door jamb, such as the jamb 4 of FIG. 8, and a second contact surface 112, which may face a door, such as the door 2. The first contact surface 110 and the second contact surface 112 abut and contact the jamb and door, or in the alternative, come so close as to preclude insertion of a person's finger or fingers into the gap. It will be recognized that for purposes of preventing insertion of fingers into a gap, the first contact surface 110 and the second contact surface 112 may contact any solid object joined to the door or to the jamb, such as for example the hinge plate 8 and the hinge plate 10.

The first panel 104 and the second panel 106 collectively form an intervening barrier disposed to engage the first contact surface 110 and the second contact surface 112. The intervening barrier so formed seals a gap such as the gap G shown in FIG. 8 to entry of a person's fingers (not shown). To this end, the intervening barrier is dimensioned and configured to occupy the gap and to substantially avoid extending outside of the gap at all of the door angles, or angles which may be defined for example between the hinge plates 8 and 10 (FIG. 8).

The gap protecting arrangement 10 may include a fastener disposed to maintain the gap protecting arrangement 10 in operable position relative to the door and the associated jamb. The fastener may comprise a loop 114 and an arm 116 which connects the loop 114 to the generally Vee-shaped member 102 and holds the loop in a position from which it can overlie a nearby hinge such as the hinge 6. The arm 116 engages the loop 114 at a predetermined orientation, and extends to and connects to the generally Vee-shaped member 102 to permit the latter to be secured to its operative position relative to the door and the jamb. Dimensions and configuration of the arm 116 may be varied to accommodate different hinge locations and dimensions. The loop 114 is dimensioned and configured to pass the shaft of a hinge pin, such as the hinge pin 12. The loop will subsequently be entrapped between an enlarged head of the hinge pin and the rest of the hinge once the hinge pin is fully installed. This holds the generally Vee-shaped member 102 in a position wherein the first panel 104 and the second panel 106 are operably positioned to cover the gap.

The gap protecting arrangement 10 may comprise a second fastener such as that having an arm 118 terminating at a second loop 120, thereby being able to engage the head of a hinge pin at a hinge (not shown) located below the hinge 6, as would apply to most doors which swing about vertical axes. It will be seen that the arm 118 is shorter than the arm 116. This configuration is suitable where the arm 116 must span the length of the hinge itself, whereas it is contemplated that the panel 112 may terminate just above the lower hinge. The requirement for locating the lower loop 120 below the panel 112 is minimal, having to clear only the head of the hinge pin. Where provided with two fasteners, the gap protecting arrangement 10 is stably secured at two opposed ends. It is possible to utilize only one fastener, such as the arm 116 and the loop 114, or alternatively, the arm 118 and the loop 120, where desired. For example, a door (not shown) may have a lowermost hinge located sufficiently above the floor as to warrant a gap protecting arrangement dimensioned and configured to protect a short gap existing below the lowermost hinge. Such a gap would present only one hinge pin for attachment of a suitable gap protecting arrangement according to the present invention.

The joint 108 is a pivotal joint in that its constituent material can flex sufficiently to enable the first panel 104 and the second panel 106 to abut a door and a jamb, such as the door 2 and the jamb 4. The joint 108 may be of a material having inherent spring characteristics urging the first panel 104 apart from the second panel 106 such that an included angle defined therebetween is maximized in the absence of forces acting to close the door.

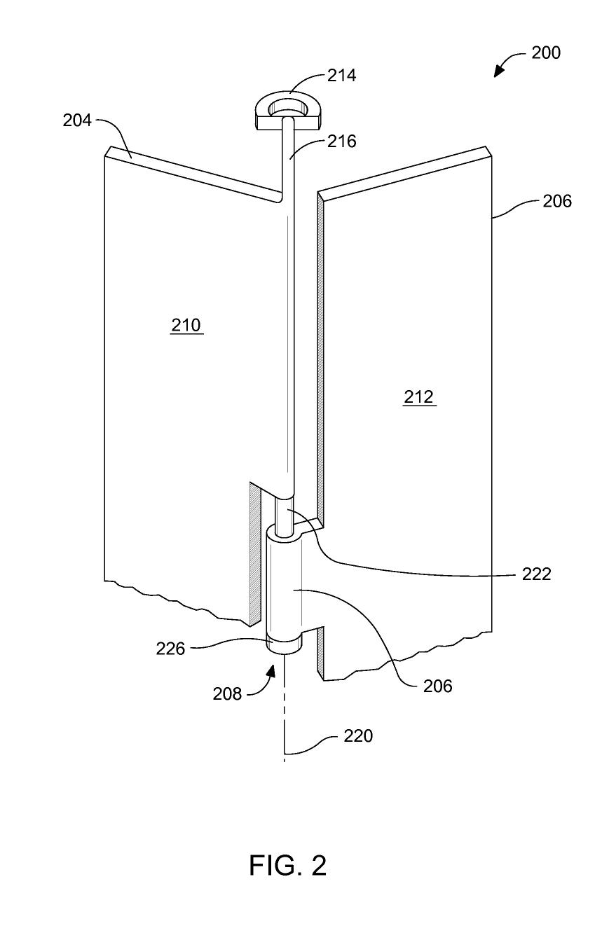

FIG. 2 shows a gap protecting arrangement 200 according to a second aspect of the invention. The gap protecting arrangement 200 has a first panel 204, a second panel 206, and a loop 214 and associated supporting arm 216 which are generally functionally and structurally similar to their similarly named counterparts in the gap protecting arrangement 100 of FIG. 1. The gap protecting arrangement 200 has, in place of the flexible joint 108, a pivotal pin joint 208. The first panel 204 and the second panel 206 can pivot relative to one another in a manner similar to the hinge 6 of FIG. 8 about an axis 220. To this end, a pin 222 may be fixed to the first panel 204, and may pivotally pass through a portion 224 of the second panel 206. The pin 222 may have an enlarged head 226 to maintain the second panel 206 engaged with the first panel 204. As with the gap protecting arrangement 100, the gap protecting arrangement substantially occupies and remains substantially within the gap, such as the gap G of FIG. 8.

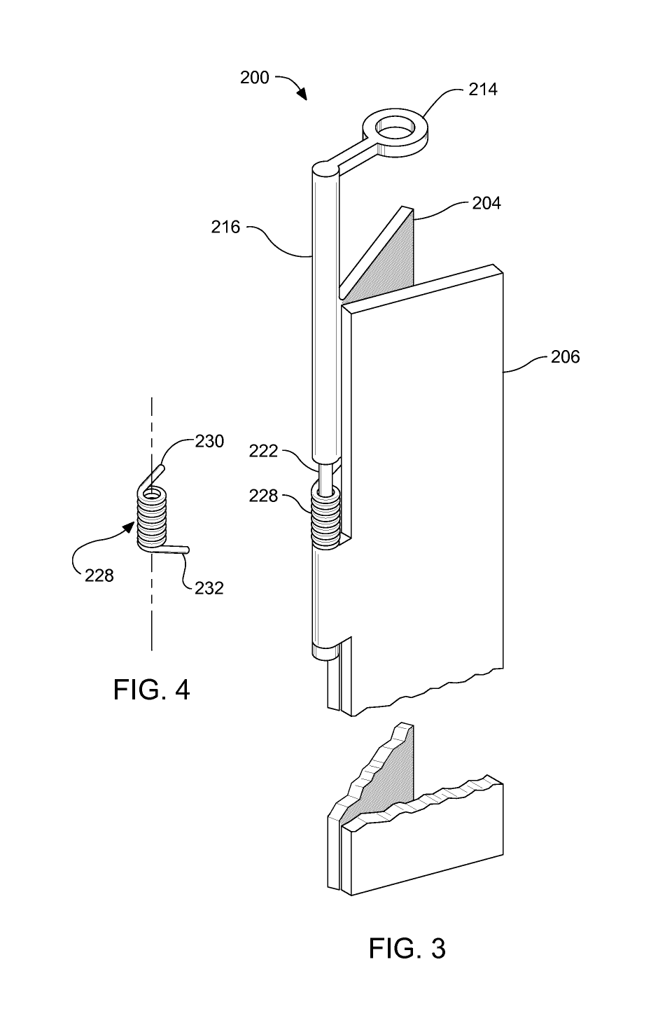

The gap protecting arrangement 200 is shown assembled in FIG. 3, where a coiled spring 228 imposes spring force characteristics on the first panel 204 and on the second panel 206, which spring force characteristics act to urge apart the first panel 204 and the second panel 206.

FIG. 4 shows the coiled spring 228 and its projecting fingers 230 and 232, which respectively engage the first panel 204 and the second panel 206 to impose spring forces thereon.

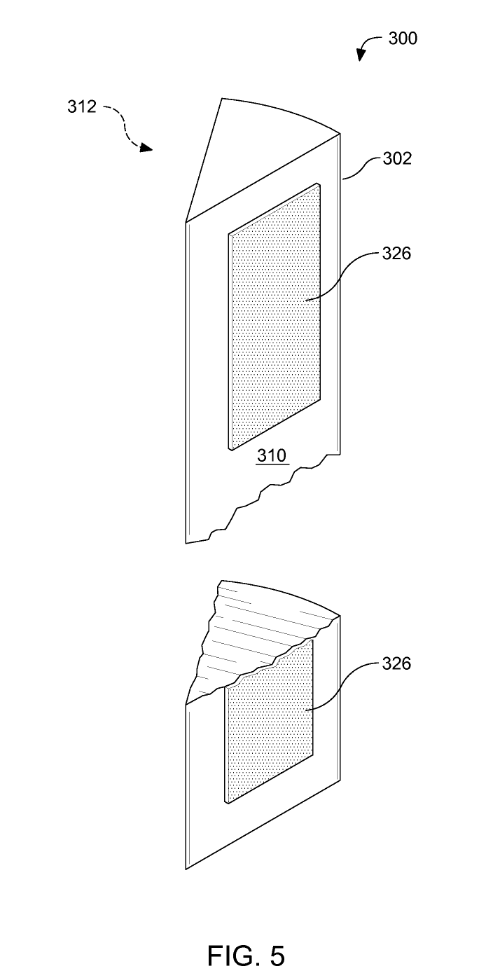

Turning now to FIG. 5, a gap protecting arrangement 300 is depicted. The gap protecting arrangement 300 comprises a wedge 302 of compressible material, such as an open cell elastomeric foam with memory properties. A first contact surface 310 is formed on one side of the wedge 302 and a second contact surface 312 is formed on an opposing side of the wedge 302. An intervening barrier which spans the first contact surface 310 and the second contact surface 312 is provided by the constituent material of the wedge 302 which extends continuously from the first contact surface 310 to the second contact surface 312. The first contact surface 310 and the second contact surface 312 are functionally equivalent to similarly named counterparts seen in the respective gap protecting arrangements 100 and 200. In the gap protecting arrangement 300, the fastener comprises adhesive 326 disposed upon at least one of the first contact surface 310 and the second contact surface 312. The adhesive 326 may take the form of one discrete patch or alternatively may comprise plural patches of adhesive.

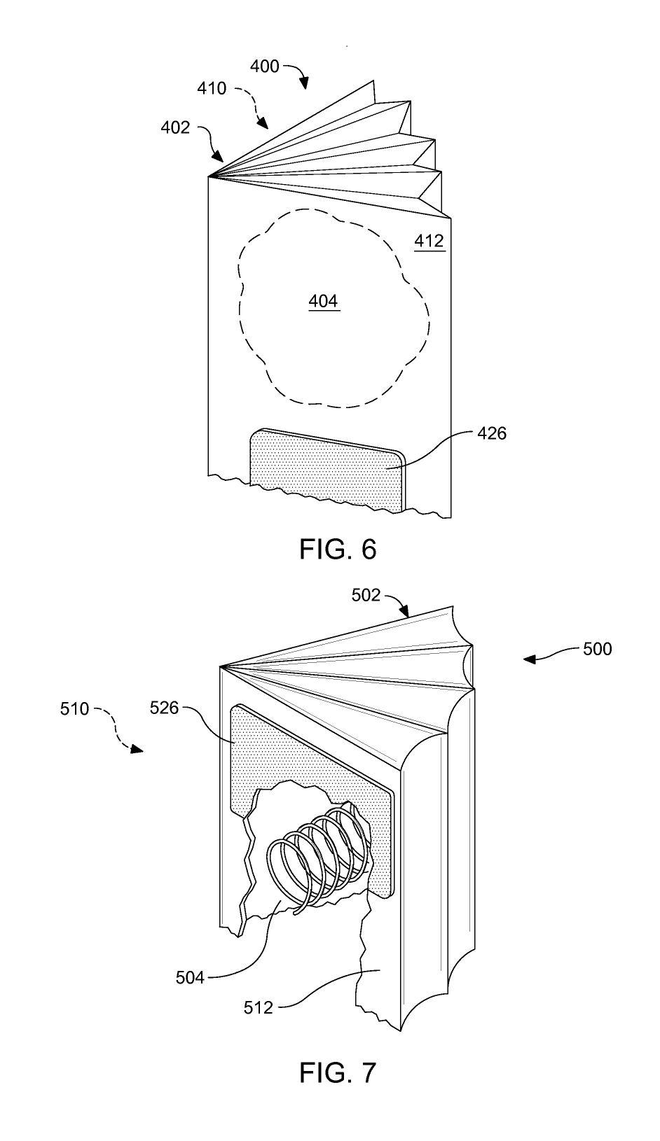

Referring now to FIG. 6, a gap protecting arrangement 400 according to still another aspect of the invention is seen to comprise a variably configured outer envelope 402 which distends responsive to opening and closing of the door, and an elastic inner material 404 contained within the variably configured outer envelope 402. The variably configured outer envelope 402 may be pleated and may fold in accordion or bellows manner responsive to opening and closing of the door. The elastic inner member 404 is biased to expand, thereby urging the variably configured outer envelope 402 to fill the gap which is generated between the door and the jamb when the door is opened. The elastic inner material 404 may comprise an elastomeric foam, a gel, other elastic material, or any combination of these.

A first contact surface 410 is disposed on one side of the variably configured outer envelope 402, and a second contact surface 412 is disposed on an opposed side of the variably configured outer envelope 402. The first contact surface 410 and the second contact surface 412 are functional equivalents of their similarly named counterparts in the gap protecting arrangements 100, 200, and 300. A fastener comprising adhesive 426 is disposed upon at least one of the first contact surface 410 and the second contact surface 412.

FIG. 7 shows a gap protecting arrangement 500 according to a further aspect of the invention. The gap protecting arrangement 500 comprises a variably configured outer envelope 502 which distends responsive to opening and closing of the door, and an elastic inner member in the form of a spring 504 contained within the variably configured outer envelope 502. The variably configured outer envelope 502 may be similar to the variably configured outer envelope 402 in that it may be pleated and may fold in accordion or bellows manner responsive to opening and closing of the door. The variably configured outer envelope 502 is shown more distended or spread open than is the relatively collapsed configuration of the variably configured outer envelope 402 of FIG. 6. The spring 504 is biased to expand, thereby urging the variably configured outer envelope 502 to fill the gap which is generated between the door and the jamb when the door is opened.

A first contact surface 510 is disposed on one side of the variably configured outer envelope 502, and a second contact surface 512 is disposed on an opposed side of the variably configured outer envelope 502. The first contact surface 510 and the second contact surface 512 are functional equivalents of their similarly named counterparts in the gap protecting arrangements 100, 200, 300, and 400. A fastener comprising adhesive 526 is disposed upon at least one of the first contact surface 510 and the second contact surface 512.

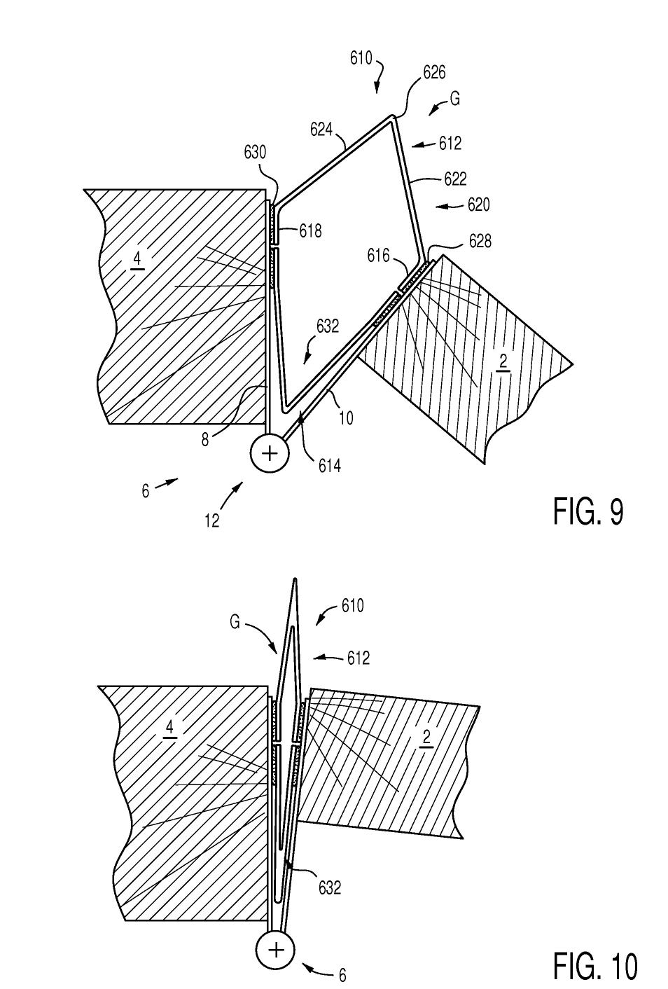

FIG. 9 shows a swinging door 2 pivotally connected to an associated jamb 4 by a hinge 6 having a first hinge plate 8 and a pivotally connected second hinge plate 10. The hinge 6 has a hinge pin 12 about which other hinge elements pivot, to enable the door 2 to be able to swing about an axis of swing relative to the door jamb 4 and to assume any of a plurality of door angles, within a limited range. The hinge pin 12 conventionally may include an enlarged head to prevent the shaft of the hinge pin 12 (the shaft is not visible in the top plan view). A gap protecting arrangement 610 is provided to obstruct insertion of small objects into the gap G which forms between the door 2 and the jamb 4. As depicted in FIG. 9, the gap protecting arrangement 610 comprises a first barrier assembly 612 and a second barrier assembly 614 disposed between the door jamb 4 and the door 2. The first barrier assembly 612 may comprise a first contact surface 616 facing the door, a second contact surface 618 facing the jamb 4, and a first intervening foldable barrier 620 disposed to engage the first contact surface 616 and the second contact surface 618. The first intervening foldable barrier 620 may comprise a first generally rigid panel 622, a second generally rigid panel 624, and a pivotal joint 626 disposed to pivotally join the first generally rigid panel 622 to the second generally rigid panel 624. The pivotal joint 626 may comprise a fold formed in the constituent material of the first generally rigid panel 622 and the second generally rigid panel 624. The first intervening foldable barrier 620 may comprise a spring feature disposed to urge the first intervening barrier 620 to expand against the door 2 and the jamb 4. The spring characteristic may arise from inherent spring characteristics of the constituent material of the first intervening foldable barrier 620, or may be provided by a separate element (not shown) if desired.

The first contact surface 616 and the second contact surface 618, which may be discrete elements unto themselves or alternatively may be a portion of the first and second generally rigid panels 622, 624, may bear respective adhering elements for detachably engaging the door 2 and the jamb 4. These adhering elements may comprise patches of adhesive 628, 630, or other materials capable of adhering, such as hook and loop fastener (not shown).

The gap protecting arrangement 610 may comprise a second barrier assembly 632 which may the structural and functional equivalent of the first barrier assembly 612 for example. The first barrier assembly 612 seals the gap G to entry of a person's fingers from one side of the door, whereas the second barrier assembly 632 seals the gap G from the other side of the door 2. The first barrier assembly 612 may be located at a first proximity to the axis of swing (which is coincident with the longitudinal axis of the hinge pin 12) and the second barrier assembly 632 may be located at a second, different proximity to the axis of swing.

FIG. 10 shows the door 2 in the closed position. The first barrier assembly 612 and the second barrier assembly 632 are both flattened, and project from the gap G so as to preclude insertion of objects thereinto.

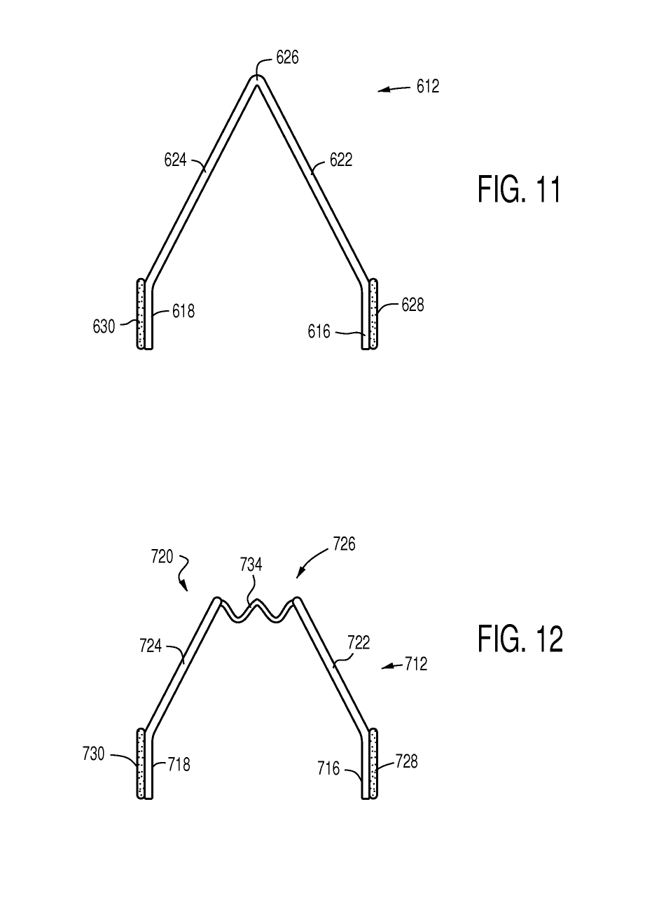

FIG. 11 shows the first barrier assembly 612 isolated from the door 2 and jamb 4.

FIG. 12 shows a barrier assembly 712 which may generally be the functional equivalent of the first barrier assembly 612, apart from the nature of a pivotal joint 726. The barrier assembly 712 may comprise a first contact surface 716, a second contact surface 718, and a foldable barrier 720 disposed to engage the first contact surface 716 and the second contact surface 718. The foldable barrier 720 may comprise a first generally rigid panel 722, a second generally rigid panel 724, and the pivotal joint 726, which is disposed to pivotally join the first generally rigid panel 722 to the second generally rigid panel 724. The pivotal joint 726 may comprise a pliable or flexible web 734, and may also comprise an elastic material. If elastic, the foldable barrier 720 may be able to stretch to accommodate opening and closing of the door 2.

The first contact surface 716 and the second contact surface 718 may bear respective adhering elements for detachably engaging the door 2 and the jamb 4, such as patches of adhesive 728, 730.

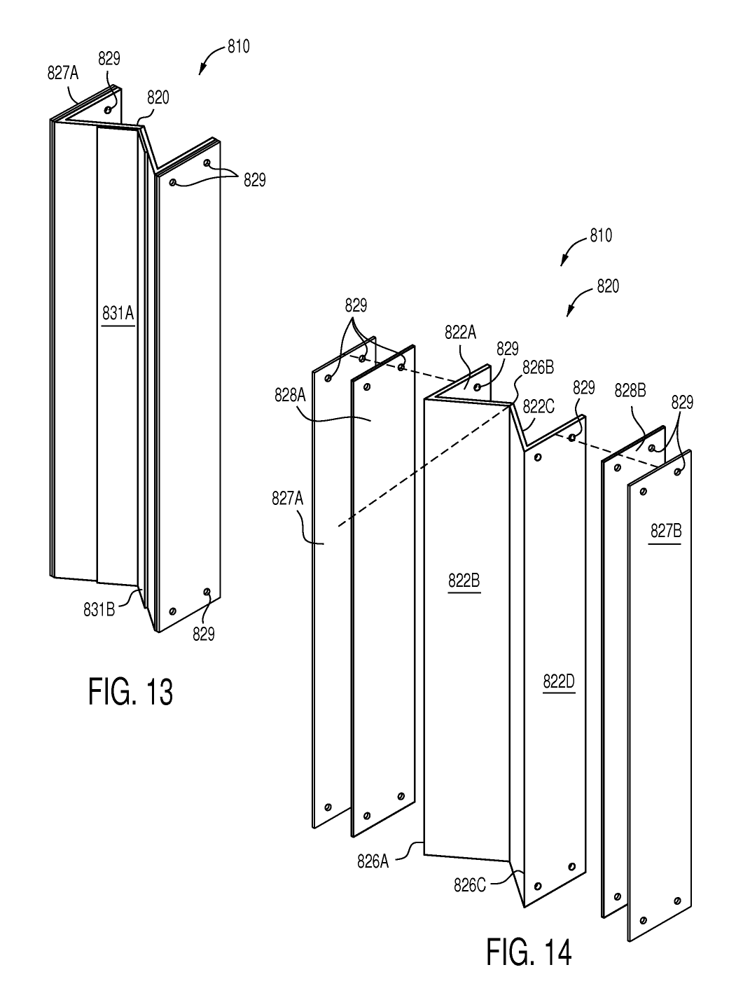

FIGS. 13 and 14 show an alternative to the barrier assemblies described above. A barrier assembly 812 of a gap protecting arrangement 810 may comprise a folding barrier 820 which is seen to comprise panels 822A, 822B, 822C, and 822D which are hinged to one another at respective pivotal joints 826A, 826B, 826C. The folding barrier 820 may be attached to a door such as the door 2 and a jamb such as the jamb 4 in the following way. A protective plate 827A may be attached to the door or to the jamb by screws (not shown), using screw holes 829. A panel 828A may be interposed between the panel 822A and the protective plate 827A. The same arrangement may be provided at the other side of the folding barrier 820, where a panel 828B may be interposed between the panel 822D and a protective plate 827B. The panels 828A, 828B may be provided as double sided adhesive elements for assuring that contact of the folding barrier 820 is continuous along its full height for example. The protective plates 827A, 827B may be used to provide a clean surface which mates well with adhesive, and may further protect surfaces of the door and the jamb from contamination due to transferred adhesive for example.

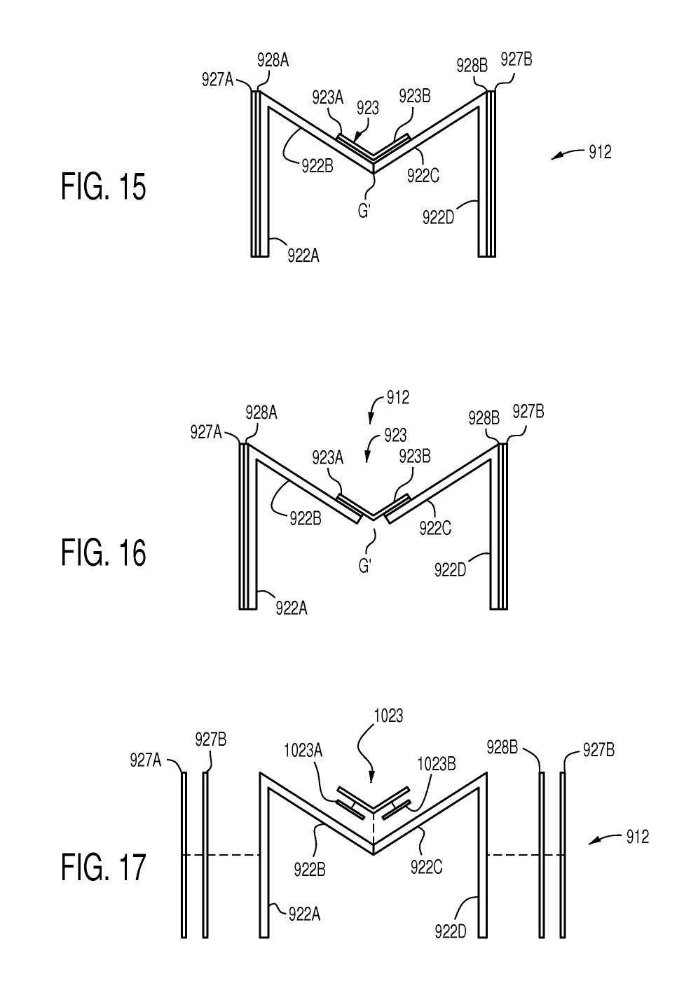

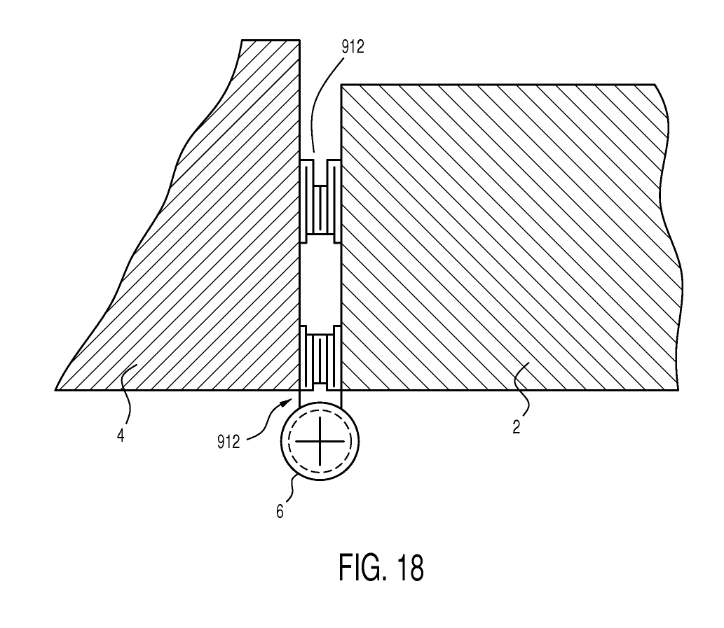

As seen in FIGS. 13 and 15, the folding barrier 820 may be reinforced by supplementary panels 831A, 831B, which may be adhered to the panels 822B, 822C. Comparison of FIGS. 13 and 15 further illustrates that the barrier assembly 812 may be provided in pairs arranged to fold in opposite directions. This may be exploited by providing one barrier assembly 812 at one face of a door such as the door 2 and the other barrier assembly 812 of the pair located at the same door gap but mounted to seal the other side of the door gap. This may be done where children may be present on both sides of the door 2, with the door gap requiring sealing or obstructing to counter penetration of the door gap by children's fingers from either side of the door 2. The two barrier assemblies 812 may be mounted in mirror image opposition to one another so that the interior panels 822B, 822C collapse inwardly when the door 2 is closed. It would be possible to arrange the barrier assemblies 812, or similar barrier assemblies to collapse or fold into a compact configuration contained entirely within the gap, as seen in FIG. 18.

Another aspect of the invention is seen in FIGS. 16 and 17. As best seen in FIG. 16, a barrier assembly 912 may be formed in two separate parts, one part including mutually joined and hinged panels 922A, 922B, and the other part including mutually joined and hinged panels 922C, 922D. A uniting panel 923 comprising a wing panel 923A and a mutually joined and hinged wing panel 923B may be joined such as by adhesive (not shown) to respective panels 922B, 922C.

If the overall width of the barrier assembly 912 happens to coincide with the overall width of the gap being sealed, then the installation may take on the characteristics shown in FIG. 15, wherein a gap G′ located between the panels 922B, 922C is substantially closed due to abutment. However, if the overall width of the gap being sealed is greater than as seen in FIG. 15, then the barrier assembly 912 may be adjusted to the configuration seen in FIG. 16. In FIG. 16, the wing panels 923A, 923B are adhered to respective panels 922B, 922C of the barrier assembly 912 such that the gap G′ is sealed.

FIG. 17 shows an alternative construction wherein a uniting panel 1023 comprises separate adhesive members 1023A, 1023B, which may be double sided adhesive tape for example. In other respects, installation of the barrier assembly 912 may be as seen in FIGS. 15 and 16.

FIG. 18 shows how two barrier assemblies such as the barrier assemblies 912 may be compactly folded or collapsed when the door 2 is closed relative to the jamb 4.

The present invention is susceptible to modifications and variations which may be introduced thereto without departing from the inventive concepts. For example, although the invention has been described with respect to doors of the type typical of buildings, it may apply equally to hatches, gates, covers, closures of all types, and pivotal windows.

Also, adhering elements such as the adhesive patches 628 and 630 (see FIG. 11) may be relocated to the opposite sides of their respective contact surfaces 616, 618, with the contact surfaces 616, 618 being bent in the opposite direction as that shown in FIG. 11.

Foldable barriers such as the foldable barriers 612, 632 may be used singly if desired, should it be deemed sufficient to protect a gap such as the gap G from insertion of objects from only one direction.

Where it is desired that the expansible member of any of the aspects of the invention have volume greater than that of the gap, it would be possible to form the door or the jamb or both to include a recess for receiving volume of the expansible member.

Although door orientation has been shown and described in terms of a vertical axis of pivot of the associated hinge, any orientation is contemplated.

The present invention is not to be considered limited to the above descriptions and forms, but rather by the scope of the appended claims.

I claim:

1. A gap protecting arrangement for obstructing insertion of small objects into the gap which forms between a door and an associated jamb to which the door is pivotally connected at a plurality of door angles, comprising:
a first contact surface facing the door;
a second contact surface facing the jamb;
an intervening barrier disposed to engage the first contact surface and the second contact surface, and to seal the gap to entry of a person's fingers, wherein the intervening barrier is dimensioned and configured such that at least a portion of the intervening barrier occupies the gap and to substantially avoid extending outside of the gap at all of the door angles; and
a fastener disposed to maintain the gap protecting arrangement in operable position relative to the door and the associated jamb.

2. The gap protecting arrangement according to claim 1, wherein the barrier comprises a first panel disposed to bear the first contact surface, a pivotally connected second panel disposed to bear the second contact surface, and a pivotal joint connecting the first panel to the second panel.

3. The gap protecting arrangement according to claim 2, wherein the pivotal joint has spring characteristics urging the first panel apart from the second panel such that an included angle defined therebetween is maximized in the absence of forces acting to close the door.

4. The gap protecting arrangement according to claim 3, wherein the spring characteristics are inherent in the constituent material of the pivotal joint.

5. The gap protecting arrangement according to claim 3, further comprising a spring disposed to impose the spring characteristics on the first panel and on the second panel.

6. The gap protecting arrangement according to claim 1, wherein the fastener comprises a loop disposed to be entrapped between a hinge and a hinge pin and to extend to and connect to the intervening barrier.

7. The gap protecting arrangement according to claim 1, further comprising a second fastener, wherein one of the fasteners is located at one end of the gap protecting arrangement and the other one of the fasteners is located at an opposed end of the gap protecting arrangement.

8. The gap protecting arrangement according to claim 1, comprising a wedge of compressible material, wherein the first contact surface is formed on one side of the wedge of compressible material, and the second contact surface is formed on an opposing side of the wedge of compressible material, and the intervening barrier is constituent material of the wedge of compressible material extending continuously from the first contact surface to the second contact surface.

9. The gap protecting arrangement according to claim 8, wherein the fastener comprises adhesive disposed upon at least one of the first contact surface and the second contact surface.

10. The gap protecting arrangement according to claim 1, wherein the intervening barrier comprises a variably configured outer envelope which distends responsive to opening and closing of the door, and an elastic inner material contained within the variably configured outer envelope, wherein
the elastic inner member is biased to expand, thereby urging the variably configured outer envelope to fill the gap which is generated between the door and the jamb when the door is opened
the first contact surface is disposed on one side of the variably configured outer envelope,
the second contact surface is disposed on an opposed side of the variably configured outer envelope, and
the fastener comprises adhesive disposed upon at least one of the first contact surface and the second contact surface.

11. The gap protecting arrangement according to claim 10, wherein the elastic inner member is a spring.

12. The gap protecting arrangement according to claim 10, wherein the variably configured outer envelope is pleated and folds in accordion manner responsive to opening and closing of the door.

13. The gap protecting arrangement according to claim 10, wherein the elastic inner member comprises a foam material.

14. The gap protecting arrangement according to claim 10, wherein the elastic inner member comprises a gel material.

15. A gap protecting arrangement for obstructing insertion of small objects into the gap which forms between a door and an associated jamb to which the door is pivotally connected at a plurality of door angles, comprising:
a first contact surface facing the door, comprising an adhering element for detachably engaging the door;
a second contact surface facing the jamb, comprising an adhering element for detachably engaging the jamb; and
an intervening barrier disposed to engage the first contact surface and the second contact surface, and to seal the gap to entry of a person's fingers, wherein the intervening barrier is dimensioned and configured to occupy the gap, and wherein the intervening barrier comprises at least one generally rigid panel and at least one foldable hinge.

16. The gap protecting arrangement according to claim 15, wherein the intervening barrier comprises a first generally rigid panel, a second generally rigid panel, and a pivotal joint disposed to pivotally join the first generally rigid panel to the second generally rigid panel.

17. The gap protecting arrangement according to claim 16, wherein the pivotal joint comprises a fold formed in the constituent material of the first generally rigid panel and the second generally rigid panel.

18. The gap protecting arrangement according to claim 16, wherein the pivotal joint comprises an elastic material, whereby the pivotal joint can stretch to accommodate opening and closing of the door.

19. The gap protecting arrangement according to claim 16, further comprising a spring feature disposed to urge the intervening barrier to expand against the door and the jamb.

20. A swinging door assembly having a gap protecting arrangement for obstructing insertion of small objects into a gap which forms between the door and an associated jamb to which the door is pivotally connected at a plurality of door angles about a common axis of swing, comprising:
a door jamb;
a door pivotally mounted to the jamb so as to be able to swing about an axis of swing relative to the door jamb;
a first barrier assembly disposed between the door jamb and the door, which said first barrier assembly comprises a first contact surface facing the door, a second contact surface facing the jamb, and a first intervening foldable barrier disposed to engage the first contact surface and the second contact surface, and to seal the gap to entry of a person's fingers; and
a second barrier assembly disposed between the door jamb and the door, wherein
the first barrier assembly is located at a first proximity to the axis of swing and the second barrier assembly is located at a second proximity to the axis of swing, which second proximity is different in magnitude from the first proximity, wherein
the first barrier assembly and the second barrier assembly each seal the gap at their respective sides of the door.
